(19) United States
(12) Patent Application Publication
(10) Pub. No.: US 2008/0232517 A1
(43) Pub. Date: Sep. 25, 2008

(54) Radio communications system, receiver and receiving method

(75) Inventors: Shigeo Terabe, Hachioji-shi (JP); Yutaka Asanuma, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/077,313

(22) Filed: Mar. 18, 2008

(30) Foreign Application Priority Data
Mar. 20, 2007 (JP) 2007-073206

(51) Int. Cl. H04L 27/06

(52) U.S. Cl. 375/344

(57) ABSTRACT

A mobile station obtains information indicating a system band to be employed from a base station before starting a process of identifying a base station ID. In the identification process, the mobile station obtains a cross-correlation value by coherent integration of pilot signals and scrambling codes which may be candidates by using a synchronization signal as a phase reference, in a channel band for synchronization, and obtains a cross-correlation value by non-coherent integration of the pilot signals and the scrambling codes by using a phase difference between sub-carriers in a frequency direction, in the system band other than the channel band for synchronization. Then, the mobile station merges these cross-correlation values, detects a scrambling code from which a maximum cross-correlation value can be obtained, and identifies the base station ID.

### CROSS-REFERENCE TO RELATED APPLICATIONS

This application is based upon and claims the benefit of priority from prior Japanese Patent Application No. 2007-073206, filed Mar. 20, 2007, the entire contents of which are incorporated herein by reference.

### BACKGROUND OF THE INVENTION

1. Field of the Invention

The present invention relates to a radio communications system such as a cellular telephone system employing OFDM (Orthogonal Frequency Division Multiplexing).

2. Description of the Related Art

Currently, 3GPP (3rd Generation Partnership Project) has started reviewing Long Term Evolution (LTE) concerning a new radio access and a radio access network following the W-CDMA (Wideband Code Division Multiple Access) system (cf., for example, 3GPP, TR25.814 (V7.1.0), “Physical Layer Aspects for Evolved UTRA”, Section 7.1.2.4, “Cell search”). This is a technical document released by the 3GPP and describes a framework of the standard relating to a physical layer.

A synchronous process described therein is a procedure by which a mobile station establishes synchronization in time and frequency with a base station on the basis of a signal received from the base station and detects an identification number of the base station.

In addition, Scalable Bandwidth for supporting a plurality of different system bands is applied to the LTE system. In a synchronization system of the LTE system, the system bands of the base stations are unknown for the mobile stations, and the mobile stations require a complicated search process to detect the system bands of the base stations and execute a process corresponding to each of the processes.

For this reason, arranging a channel to notify a synchronization channel and system information in a system band common to the base stations employing any system bands and transmitting signals from the base stations to the mobile stations has been conceived to simplify the search process of the system bands. The mobile stations can thereby carry out the synchronous process by receiving the synchronization channel and the system information notification channel arranged in a predetermined common system band even if the system bands of the base stations are unknown.

In addition, reduction of the needed time and improvement of the accuracy are required in such a synchronous process.

The conventionally reviewed radio communications system is required to improve the accuracy in the synchronous process and reduce the time required therefor.

### BRIEF SUMMARY OF THE INVENTION

The present invention has been accomplished to solve the above-described problems. The object of the present invention is to provide a radio communications system, a receiver and a receiving method capable of improving the accuracy in the synchronous process and reducing the time required therefor.

To achieve the object, an aspect of the present invention is a receiver receiving information radio-transmitted from a transmitter in OFDM system. The receiver comprises a receiving unit which receives system information indicating a first frequency band employed for radio transmission from the transmitter; a first detector which, for a pilot signal allocated to a sub-carrier in a preset second frequency band, of the first frequency band indicated by the system information, executes coherent detection employing a synchronization signal allocated to the sub-carrier; a second detector which executes non-coherent detection for a pilot signal allocated to a sub-carrier in a frequency band other than the second frequency band, of the first frequency band indicated by the system information; and an identifier which determines the transmitter to be received, in accordance with a detection result of the first detector and a detection result of the second detector.

In the present invention, as described above, coherent detection using the synchronization signal is executed for the pilot signal allocated to the sub-carrier in the preset second frequency band, of the first frequency band indicated as the system information, while non-coherent detection is executed for the pilot signal allocated to the sub-carrier in the first frequency band other than the second frequency band. On the basis of these detection results, the transmitter to be received is determined.

Therefore, according to the present invention, since the transmitter to be received is determined by using only the pilot signal in the second frequency band in which the synchronization signal is allocated to the sub-carrier, but also the other pilot signal in the first frequency band, the radio communications system, receiver and receiving method capable of improving the accuracy in the synchronization process for determining the transmitter to be received and of reducing the required time, can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a synchronous process of a radio communications system according to the present invention;

FIG. 2 is an illustration showing a signal arrangement on a sub-carrier of a radio signal used in the radio communications system according to the present invention;

FIG. 3 is a block diagram showing a structure of a transmitter in the radio communications system according to the present invention;

FIG. 4 is a block diagram showing a structure of a receiver in the radio communications system according to the present invention;

FIG. 5 is an illustration showing an operation of a base station ID identifying unit of the receiver shown in FIG. 4; and

FIG. 6 is an illustration showing an operation of the base station ID identifying unit of the receiver shown in FIG. 4.

### DETAILED DESCRIPTION OF THE INVENTION

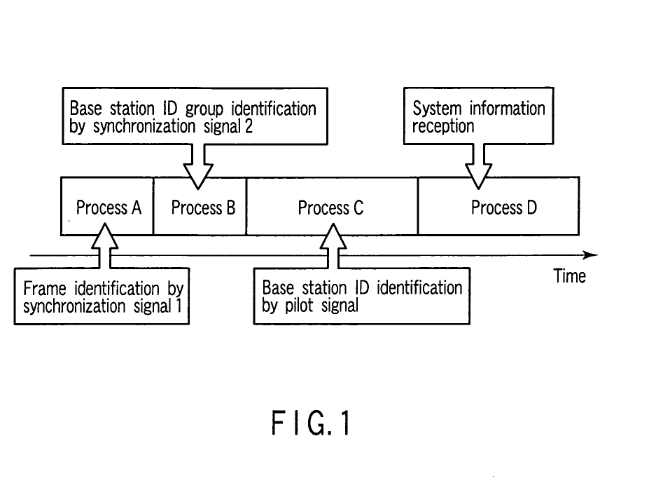

Embodiments of the present invention will be explained below with reference to the accompanying drawings. In the following descriptions, a transmitter is a base station and a receiver is a mobile station. In addition, OFDM (Orthogonal Frequency Division Multiplexing) is employed as the communications system, and the synchronous process at the mobile station consists of a routine shown in FIG. 1. In other words, the synchronous process consists of process A, process B, process C and process D, and is executed in this order.

In process A, the mobile station detects a timing of cutting out a time frame boundary, i.e. a sampling data sequence for executing GI (guard interval) removal and FFT operation, from a time sequence of a received signal, by obtaining a cross-correlation between a baseband digital signal at each sampling time and a known synchronous code included in synchronization signal 1. As the other method of frame synchronization, a method using a synchronous code having a repeated waveform in a time domain is conceived. In this case, the time frame boundary is detected by auto-correlation.

In process B and process C, the mobile station divides the sampling data sequence of the baseband digital signal into signals in the frequency domain, i.e. signals of respective sub-carriers by multiplying a time frame unit obtained in process A, by the FFT, and identifies base station ID by information in the frequency domain. In general, to reduce an identifying time of the base station ID in the cellular system, identification of the base station ID is executed in two steps, i.e. identifying a base station ID group in process B and then identifying the base station ID of the base station ID group in process C.

This example is based on use of synchronization signal 2 in process B and use of a pilot signal which is also used for channel equivalence of data signal or measurement of the received signal from each base station, in process C. An inherent scrambling code of the base station is applied to the pilot signal to enable interference between the base stations to be reduced and the receiving power of each base station to be measured. For this reason, in process C, the base station ID is identified by a cross-correlation operation with a scrambling code candidate of each of the base stations in the base station ID group identified before process B.

Finally, in process D, system information channel (P-BCH) is received. At this time, the pilot signal is used for channel equivalence of the system information channel.

As described above, the process executed until a basic system parameter necessary for establishing communications is defined as synchronous process. One of purposes of the synchronous process is to identify the base station ID by identifying the inherent scrambling code sequence of the base station ID applied to the pilot signal.

Incidentally, in a cellular system of Scalable Bandwidths in which a plurality of band widths are supported as system bands used for the transmission by the base station, the system bands are unclear at the mobile station when the above-described synchronous process starts. For this reason, a synchronization signal is arranged in the only channel band for synchronization common to all the base stations, in the radio communications system to be described below.

By executing processes A and B in the channel band for synchronization, the mobile station can carry out the synchronous process with stable synchronizing performance without knowing the system band of the base station and can simplify the synchronous search process. On the other hand, the pilot signal used for process C is arranged over the system band since it is used as a phase reference signal at data demodulation as an object other than the synchronization.

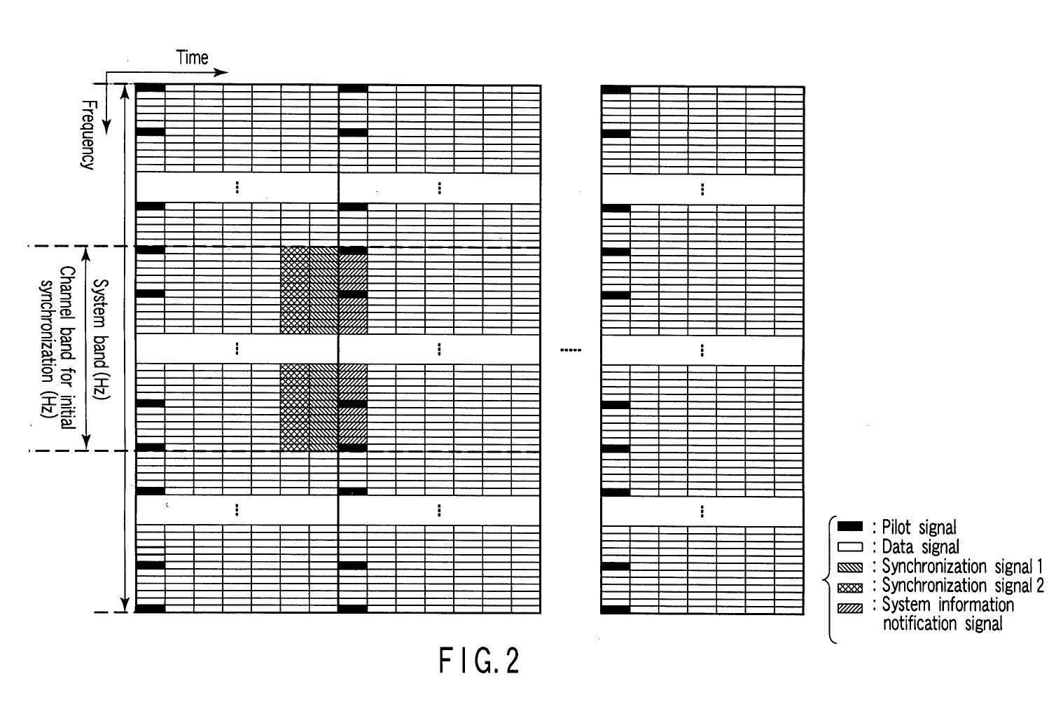

An example of thus arranging synchronization signals and pilot signals at sub-carriers is shown in FIG. 2. In this example, the synchronization signals are arranged at all the sub-carriers in the channel band for synchronization and the pilot signals are cyclically arranged at a density of one of six sub-carriers in a frequency direction, over the system band.

The radio communications system according to the present invention notifies the mobile station of the system band used by the base station before starting process C. More specifically, the mobile station is notified of the system band as the system information by using the synchronization signals used in process A and process B, or the mobile station demodulates signals other than the synchronization signals and receives notification from the base station before starting process C.

However, since the synchronization signals are arranged in the only channel band for synchronization between the base stations as shown in FIG. 2, there is no signal as the phase reference for detection of coherent in process C even if the mobile station recognizes that the system band of the base station is broader than the common system band.

For this reason, process C cannot be executed by using the pilot signals arranged over the system band, and process C is executed by using the only pilot signals in the system band width in which the synchronization signals are arranged.

On the other hand, in the radio communications system according to the present invention, the cross-correlation is obtained by applying the coherent detection using the synchronization signals to the pilot signals arranged in the channel band for synchronization, and the cross-correlation is also obtained by applying the non-coherent detection to the pilot signals arranged in the other system bands. The power values of the cross-correlations are merged, the maximum cross-correlation is detected and the base station ID is identified.

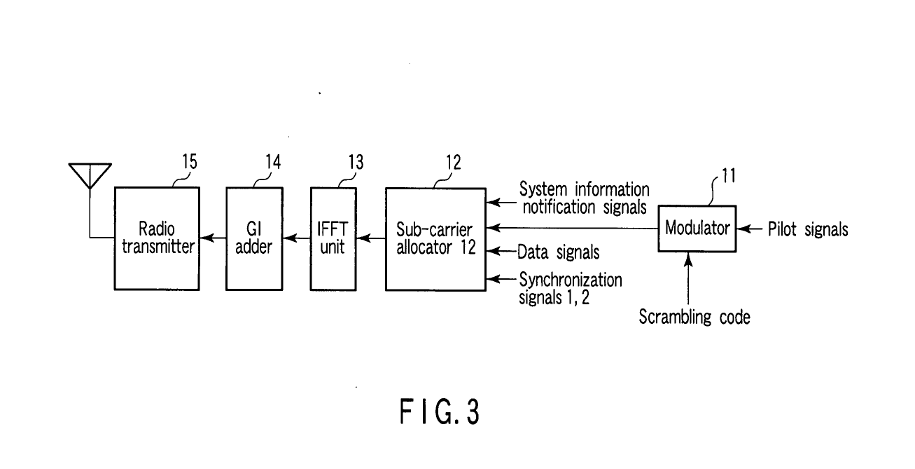

FIG. 3 shows an example of a configuration of the base station, i.e. OFDM transmitter. The base station comprises a modulator 11, a sub-carrier allocator 12, an IFFT (Inverse Fast Fourier Transform) unit 13, a GI (Guard Interval) adder 14 and a radio transmitter 15.

The modulator 11 multiplies the pilot signals by the scrambling code allocated inherently to the base station to enable the reduction of interference with the other base stations and enable the mobile station to measure the receiving power for each of the base stations.

The sub-carrier allocator 12 inputs the system information notification signals, the pilot signals modulated by the modulator 11, data signals, and synchronization signals 1, 2 and allocates these signals to predetermined sub-carriers as shown in FIG. 2. The sub-carrier allocator 12 preliminarily recognizes the frequency of the channel band for synchronization. The system information notification signals include system information elements such as the system band used for the transmission by the base station, the number of transmission antennas and the like.

The IFFT unit 13 executes OFDM modulation for the output signal of the sub-carrier allocator 12 and generates an OFDM signal as a sequence of a plurality of OFDM symbols. In other words, the IFFT unit 13 generates an OFDM signal by converting the signal of the frequency domain into the signal of the time domain.

The GI adder 14 adds a guard interval (GI) to the OFDM signal generated by the IFFT unit 13.

The radio transmitter 15 comprises a digital/analog converter which executes digital/analog conversion of the output from the GI adder 14, an up-converter which up-converts the analog output to an RF signal, and a power amplifier which amplifies the power of the RF signal. The RF signal subjected to power amplification by the power amplifier is emitted into space via the antennas.

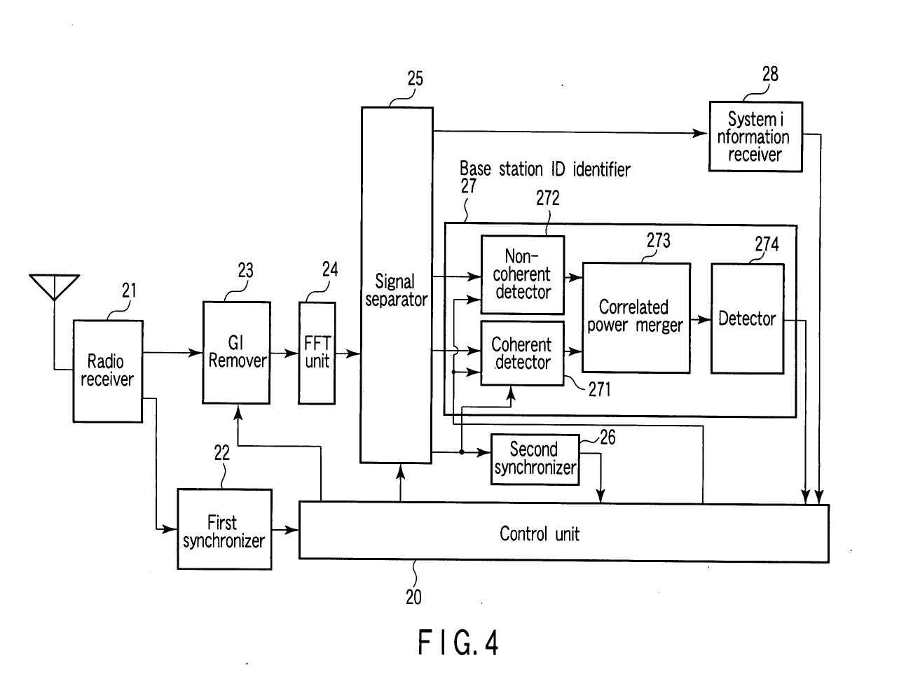

FIG. 4 shows an example of a configuration concerning the synchronous process of the mobile station, i.e. OFDM receiver. The mobile station comprises a radio receiver 21, a first synchronizer 22, a GI remover 23, an FFT (Fast Fourier Transform) unit 24, a signal separator 25, a second synchronizer 26, a base station ID identifier 27, and a system information receiver 28. The mobile station preliminarily recognizes the frequency of the channel band for synchronization.

The radio receiver 21 has a band-pass filter which removes noise outside a desired band from an RF signal received from space by the antenna, and an A/D converter which executes analog/digital conversion for the RF signal passing through the band-pass filter and obtains a baseband digital signal.

The first synchronizer 22 executes the process A shown in FIG. 1. The first synchronizer 22 detects a timing of cutting out a time frame boundary, i.e. a sampling data sequence for executing GI removal and FFT operation, from a time sequence of the baseband digital signal, by obtaining a cross-correlation between the baseband digital signal at each sampling time and a known synchronous code included in synchronization signal 1.

The control unit 20 is notified of this timing. The control unit 20 thereby recognizes the timing of cutting out the sampling data sequence for executing GI removal and FFT operation, and the positions (time and frequency) on the sub-carriers at which the signals are arranged.

As for the frame synchronization, other than this, a method using a synchronization code having a repeated waveform in the time domain is conceived. In this case, the time frame boundary is detected by auto-correlation.

The GI remover 23, the FFT unit 24, the signal separator 25 and the second synchronizer 26 execute process B shown in FIG. 1.

The GI remover 23 is notified of the timing detected by the first synchronizer 22, by the control unit 20. At this timing, the GI remover 23 removes the guard interval from the baseband digital signal.

The FFT unit 24 is notified of the timing detected by the first synchronizer 22, by the control unit 20. At this timing, the FFT unit 24 executes FFT operation for the baseband signal and converts the signal in the time domain, in the baseband digital signal, into the signal in the frequency domain. The baseband digital signal is thereby divided into signals for the sub-carriers.

The signal separator 25 separates the signals for the sub-carriers obtained by the FFT unit 24 into the system information notification signal, pilot signal, data signal, synchronization signal 2, and the like, in accordance with instructions from the control unit 20. The system information notification signal is input to the system information receiver 28. The pilot signal is input to the base station ID identifier 27. The synchronization signal 2 is input to the second synchronizer 26 and the base station ID identifier 27.

The second synchronizer 26 identifies the base station ID group from the synchronization signal 2. The control unit 20 is notified of identification information of the base station ID group thus identified. The control unit 20 preliminarily stores the scrambling code allocated inherently to each base station, for each base station ID group. The second synchronizer 26 notifies the base station ID identifier 27 of scrambling codes q1(f), q2(f), q3(f) . . . (f=0, 1, . . . , N: total number of pilot sub-carriers) allocated inherently to the base stations in the base station ID group notified by the second synchronizer 26.

The base station ID identifier 27 detects the scrambling code for specifying the base station ID by executing process C shown in FIG. 1. The base station ID identifier 27 comprises a coherent detector 271, a non-coherent detector 272, a corrected power merger 273 and a detector 274.

The coherent detector 271 inputs the pilot signal of the channel band for synchronization common to the plurality of base stations, of the pilot signals shown in FIG. 2. Then, the coherent detector 271 executes a cross-correlation operation of the pilot signal and the plurality of scrambling codes q1(f), q2(f), q3(f) . . . notified by the control unit 20 to obtain the cross-correlation value.

For more detailed explanation, the sub-carrier frequency arranged in the channel band for synchronization is represented as f=0, 1, . . . , N, synchronization signal 2 is represented as s(f), the pilot signals are represented as p(f) and a transmission path estimate value is represented as h(f). Since s(f) sequence is also known to the mobile station, h(f) (f=0, 1, . . . , N) can be obtained from the synchronization signal s(f)h(f) received at the mobile station.

Therefore, the coherent detector 271 obtains the cross-correlation value from a coherent integration of the pilot signals p(f) (f=0, 1, . . . , N) and the scrambling codes q1(f), q2(f), q3(f) . . . notified by the control unit 20, by using synchronization signal s(f) as the phase reference. This coherent integration is represented below in formula (1).

$$E ( n ) = {\sum }_{f = 1}^{N} \begin{matrix}( p ( f ) \cdot h ( f ) ) \cdot \\ {( {q}_{n} ( f ) \cdot h ( f ) )}^{*}\end{matrix} = {\vert {q}_{n} ( f ) \vert}^{2} {\vert h ( f ) \vert}^{2} \qquad ( 1 )$$

The non-coherent detector 272 inputs the pilot signal in the system band other than the above channel band for synchronization, of the pilot signals shown in FIG. 2. Then, the non-coherent detector 272 executes a cross-correlation operation of a differential vector between two pilot sub-carriers proximate to the pilot signals and a cross-correlation operation of a differential vector between two pilot sub-carriers corresponding to the plurality of scrambling codes q1(f), q2(f), q3(f) . . . notified by the control unit 20, without using the phase reference signal, and obtains the cross-correlation value.

For more detailed explanation, the sub-carrier frequencies arranged in the stream band other than the channel band for synchronization are represented as f=N+1, N+2, . . . , M, the pilot signals are represented as p(f), and the transmission path estimate value is represented as h(f).

The pilot signals r(f), r(f+1) received by the respective mobile stations can be represented below by using proximate sub-carrier frequencies f, f+1.

r(f)=p(f)h(f)

r(f+1)=p(f+1)h(f+1)

It is assumed that the channel variation can be neglected in the proximate sub-carriers where h(f)=h(f+1).

The non-coherent detector 272 executes cross-correlation operations of differential vectors between proximate sub-carriers to the pilot signals and the plurality of scrambling codes q1(f), q2(f), q3(f) . . . notified by the control unit 20, by using the vector difference between the sub-carriers, processes them by non-coherent integration, and obtains the cross-correlation value. The non-coherent integration is represented below in formula (2).

$$\begin{matrix}D ( n ) = {\sum }_{f = N}^{M} ( r ( f + 1 ) \cdot {r ( f )}^{*} ) \cdot {( {q}_{n} ( f + 1 ) \cdot {q}_{n} ( f ) )}^{*} \\ = {\sum }_{f = N}^{M} ( p ( f + 1 ) \cdot {p ( f )}^{*} ) {\vert h ( f ) \vert}^{2} \cdot {( {q}_{n} ( f + 1 ) \cdot {q}_{n} ( f ) )}^{*} \\ = {\vert {m}_{n} ( f ) \vert}^{2} {\vert h ( f ) \vert}^{2}\end{matrix} \qquad ( 2 )$$

The corrected power merger 273 merges the cross-correlation value obtained by the coherent detector 271 with the cross-correlation value obtained by the non-coherent detector 272. The detector 274 detects scrambling code qn(F) from which the maximum cross-correlation value is obtained, from the merging result, and notifies the control unit 20 of the scrambling code qn(F). The operation in the corrected power merger 273 and the detector 274 is represented below in formula (3).

$${max arg}_{n = 1 , … , 3} ( E ( n ) + D ( n ) ) \qquad ( 3 )$$

The control unit 20 thereby recognizes the base station to be received as the base station corresponding to the scrambling code qn(F), and identifies the base station ID. After that, the control unit 20 controls all the units to receive the pilot signals by using the scrambling code qn(F).

The system information receiver 28 executes synchronous detection of the system information notification signal input from the signal separator 25, by using the phase reference signal generated by applying the scrambling code qn(F) notified by the control unit 20 to the pilot signals, and thereby obtains the system information.

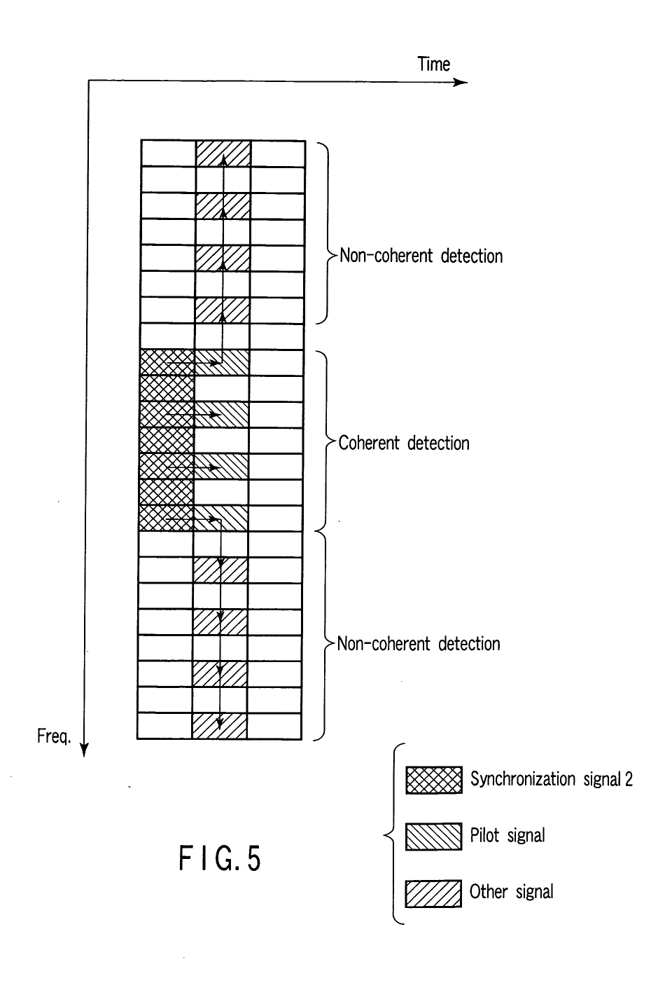

In the radio communications system having the above-described configuration, the mobile station obtains the information indicating the system band used by the base station, before starting the base station ID identification process in process C. In process C, as shown in FIG. 5, the mobile station obtains the cross-correlation value by the coherent integration of the pilot signals and the scrambling code which becomes a candidate by considering the synchronization signal as phase reference, in the channel band for synchronization, and also obtains the cross-correlation value by the non-coherent integration of the pilot signals and the scrambling code, by using the differential vector between the proximate pilot sub-carriers, in the system band other than the channel band for synchronization. The mobile station merges these cross-correlation values, detects the scrambling code from which the maximum cross-correlation values can be obtained, and identifies the base station ID.

Therefore, since the cross-correlation values are obtained by using the pilot signal in the system band used other than the channel band for synchronization, accuracy of identifying the base station ID is improved. In addition, since the base station ID can be specified at a high accuracy, the process time required to execute process D can be reduced.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the non-coherent detector 272 executes cross-correlation operations of differential vectors between proximate sub-carriers to the pilot signals and the plurality of scrambling codes notified by the control unit 20, by using the vector difference between the sub-carriers, processes them by non-coherent integration, and obtains the cross-correlation value, as shown in FIG. 5.

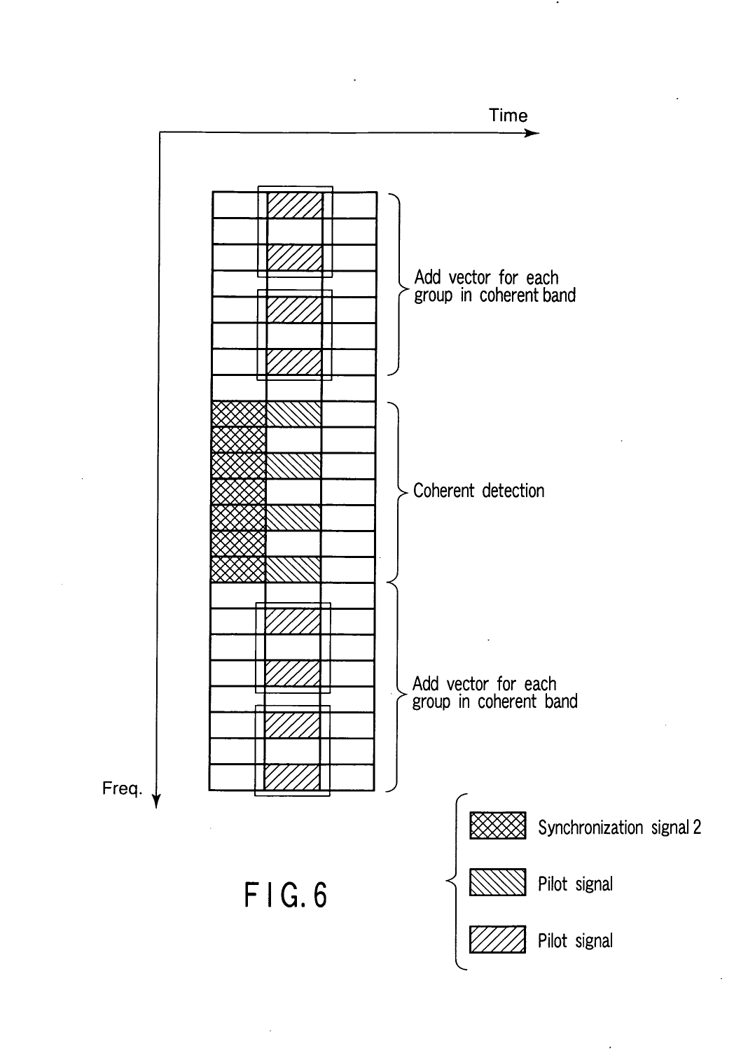

Instead of this, for example, the non-coherent detector 272 may group the sub-carriers adjacent in the frequency direction, execute coherent addition of the pilot signals for each of the groups, execute cross-correlation operations of the addition results and a plurality of scrambling codes notified by the control unit 20, merge the operation results and obtain the cross-correlation value, as shown in FIG. 6. The coherent addition for each of the groups indicates a process of integrating the vector differences from the scrambling code candidates without considering the channel variation in each frequency bandwidth in which it can be assumed that no channel variation occurs, in the communications path of the cellular system.

Furthermore, the synchronization signals are not arranged in the system band other than the channel band for synchronization in the above-described embodiment. However, the present invention can also be applied to a case where the synchronization signals are arranged in a part of the system band.

The present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receiver receiving information radio-transmitted from a transmitter in OFDM system, the transceiver being configured to transmit a pilot signal using a peculiar code, the receiver comprising:
a receiving unit which receives system information indicating a first frequency band employed for radio transmission from the transmitter;
a first detector which, for the pilot signal allocated to a sub-carrier in a preset second frequency band, of the first frequency band indicated by the system information, executes coherent detection employing a synchronization signal allocated to the sub-carrier;
a second detector which executes non-coherent detection for the pilot signal allocated to a sub-carrier in a frequency band other than the second frequency band, of the first frequency band indicated by the system information; and
an identifier which determines the transmitter to be received, in accordance with a detection result of the first detector and a detection result of the second detector.

2. The receiver according to claim 1, wherein the second detector executes the non-coherent detection using a vector difference between a plurality of pilot signals allocated to the sub-carrier of the same timing in the frequency band other than the second frequency band, of the first frequency band indicated by the system information.

3. The receiver according to claim 1, wherein the second detector groups a plurality of pilot signals allocated to the sub-carrier of the same timing in the frequency band other than the second frequency band, of the first frequency band indicated by the system information, executes coherent addition of the pilot signals for each of groups, and executes the non-coherent detection using a result of the addition.

4. The receiver according to claim 1, wherein the identifier determines the transmitter to be received, in accordance with a result of merging a detection result of the first detector and a detection result of the second detector.

5. A method of receiving information radio-transmitted from a transmitter in OFDM system, the transceiver being configured to transmit a pilot signal using a peculiar code, the method comprising:
a receiving step of receiving system information indicating a first frequency band employed for radio transmission from the transmitter;
a first detecting step of, for the pilot signal allocated to a sub-carrier in a preset second frequency band, of the first frequency band indicated by the system information, executing coherent detection employing a synchronization signal allocated to the sub-carrier;
a second detecting step of executing non-coherent detection for the pilot signal allocated to a sub-carrier in a frequency band other than the second frequency band, of the first frequency band indicated by the system information; and
an identifying step of determining the transmitter to be received, in accordance with a detection result of the first detecting step and a detection result of the second detecting step.

6. The method according to claim 5, wherein the second detecting step executes the non-coherent detection using a vector difference between a plurality of pilot signals allocated to the sub-carrier of the same timing in the frequency band other than the second frequency band, of the first frequency band indicated by the system information.

7. The method according to claim 5, wherein the second detecting step groups a plurality of pilot signals allocated to the sub-carrier of the same timing in the frequency band other than the second frequency band, of the first frequency band indicated by the system information, executes coherent addition of the pilot signals for each of groups, and executes the non-coherent detection using a result of the addition.

8. The method according to claim 5, wherein the identifying step determines the transmitter to be received, in accordance with a result of merging a detection result of the first detecting step and a detection result of the second detecting step.

9. A radio communications system allowing a receiver to receive information radio-transmitted from a transmitter in OFDM system, the transceiver being configured to transmit a pilot signal using a peculiar code,
the transmitter comprising a transmitting unit which transmits system information indicating a first frequency band employed for radio transmission to the receiver,
the receiver comprising:
a receiving unit which receives system information indicating a first frequency band employed for radio transmission from the transmitter;
a first detector which, for the pilot signal allocated to a sub-carrier in a preset second frequency band, of the first frequency band indicated by the system information, executes coherent detection employing a synchronization signal allocated to the sub-carrier;
a second detector which executes non-coherent detection for the pilot signal allocated to a sub-carrier in a frequency band other than the second frequency band, of the first frequency band indicated by the system information; and
an identifier which determines the transmitter to be received, in accordance with a detection result of the first detector and a detection result of the second detector.

10. The system according to claim 9, wherein the second detector executes the non-coherent detection using a vector difference between a plurality of pilot signals allocated to the sub-carrier of the same timing in the frequency band other than the second frequency band, of the first frequency band indicated by the system information.

11. The receiver according to claim 9, wherein the second detector groups a plurality of pilot signals allocated to the sub-carrier of the same timing in the frequency band other than the second frequency band, of the first frequency band indicated by the system information, executes coherent addition of the pilot signals for each of groups, and executes the non-coherent detection using a result of the addition.

12. The receiver according to claim 9, wherein the identifier determines the transmitter to be received, in accordance with a result of merging a detection result of the first detector and a detection result of the second detector.
